(19) United States
(12) Patent Application Publication
(10) Pub. No.: US 2017/0171651 A1
(43) Pub. Date: Jun. 15, 2017

(54) Electric Device Including Microspeaker Module with Vibration Function

(71) Applicant: EM-TECH. Co., Ltd., Busan (KR)

(72) Inventors: Yong Ju Ji, Gyeongsangnam-do (KR); Joong Hak Kwon, Gyeongsangnam-do (KR)

(21) Appl. No.: 14/963,955

(22) Filed: Dec. 9, 2015

(51) Int. Cl. H04R 1/02; H04R 3/00

(52) U.S. Cl. CPC H04R 1/028; H04R 1/025; H04R 3/00; H04R 2400/03

(57) ABSTRACT

An electric device includes a microspeaker module including an enclosure having a rectangular shape and serving as a sound box for generating sound pressure therein, a microspeaker installed on an upper surface of the enclosure for changing an electrical signal into sound pressure to generate vibration of air, and a subordinate vibration unit installed within the enclosure for vibrating, and a control unit for applying the electric signal to the microspeaker module to perform a vibration function and a sound emission function.

### TECHNICAL FIELD

The present invention relates to an electric device including a microspeaker module with a vibration function and, more particularly, to an electric device including a microspeaker module with both a vibration function and a sound emission (sound reproduction) function.

### BACKGROUND

A microspeaker module is a device for generating vibration of air by an electric signal and reproducing the generated vibration as a sound. As illustrated in FIG. 1, the microspeaker module with a vibration function generally has a shape of rectangular parallelepiped and includes an enclosure 1 serving as a sound box generating sound pressure therein, a microspeaker 2 installed on an upper surface of the enclosure 1 and changing an electrical signal into acoustic pressure to generate vibration of air, and a vibration motor 4 installed within the enclosure 1.

The enclosure 1, a part forming an overall external appearance of the microspeaker module, generally has a shape of a rectangular parallelepiped and has an opening 3 provided on an upper surface thereof to allow the microspeaker 2 to be installed therein.

The vibration module 4 performs a vibration function in response to an electric signal from an electric device.

In case of a general microspeaker module, a magnitude of a back volume of a device in which the microspeaker module is installed significantly affects sound characteristics of the microspeaker module. According to Helmholtz Equation for resonance, a back volume greatly affects equivalent stiffness of air, and thus, as the back volume is smaller, equivalent stiffness is increased to lower sound pressure of a low band and increase a first order resonance frequency.

In particular, in an electric device such as a smartphone or a tablet PC, a microspeaker module takes a small space, considerably reducing a back volume, causing sound pressure to be further lowered in a low band.

In addition, when a vibration motor 4 is installed within the enclosure 1, the back volume is considerably reduced, and as illustrated in FIG. 2, in addition to a signal input unit toward the microspeaker 2, a signal input unit toward the vibration motor 2 needs to be provided, causing a problem in that it is not easy to lead these signal input units to outside when assembling the enclosure 1.

### SUMMARY

An object of the present invention is to provide an electric device including a microspeaker module with a vibration function, capable of solving a limitation in reproducing a sound due to limited capacity (installation space) and performing a vibration function even without a vibration motor.

According to an aspect of the present invention for achieving the above objects, there is provided an electric device including: a microspeaker module including an enclosure having a rectangular shape for serving as a sound box generating sound pressure therein, a microspeaker installed on an upper surface of the enclosure for changing an electrical signal into sound pressure to generate vibration of air, and a subordinate vibration unit installed within the enclosure for vibrating, and a control unit for applying the electric signal to a microspeaker module to perform a vibration function and a sound emission function.

The subordinate vibration unit includes a vibration plate including an installation portion attached to a lower surface of an upper part of the enclosure, a central portion on which a main body portion is installed, and a dome portion connecting the installation portion and the central portion. The main body portion is formed of an iron, copper, or tungsten-based metal having high specific gravity to increase weight of the vibration plate.

According to an embodiment of the present invention, a limitation in reproducing a sound due to limited capacity (installation space) within an electric device may be solved, a vibration function may be performed even without a vibration motor, and an intrinsic sound emission function may be performed.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 is a cross-sectional view of a microspeaker module according to a related art.

FIG. 2 is a plan view of the microspeaker of FIG. 1.

FIG. 3 is a perspective view of a microspeaker module having a subordinate vibration unit according to an embodiment of the present invention.

FIG. 4 is a schematic cross-sectional view of the microspeaker module of FIG. 3.

FIG. 5 is a detailed perspective view of the subordinate vibration unit of FIG. 3.

FIG. 6 is a plan view of the microspeaker of FIG. 3.

FIG. 7 is a block diagram of an electric device including the microspeaker of FIG. 3.

FIG. 8 is a graph illustrating sound pressure characteristics of the present invention and the related art.

FIGS. 9A and 9B are graphs illustrating sound pressure characteristics of the subordinate vibration unit and a microspeaker.

FIG. 10 is a graph illustrating phase characteristics of the subordinate vibration unit and the microspeaker.

FIGS. 11A and 11B are views illustrating various examples of vibration plates of a subordinate vibration unit.

FIG. 12 is a view illustrating a microspeaker module according to another embodiment of the present invention.

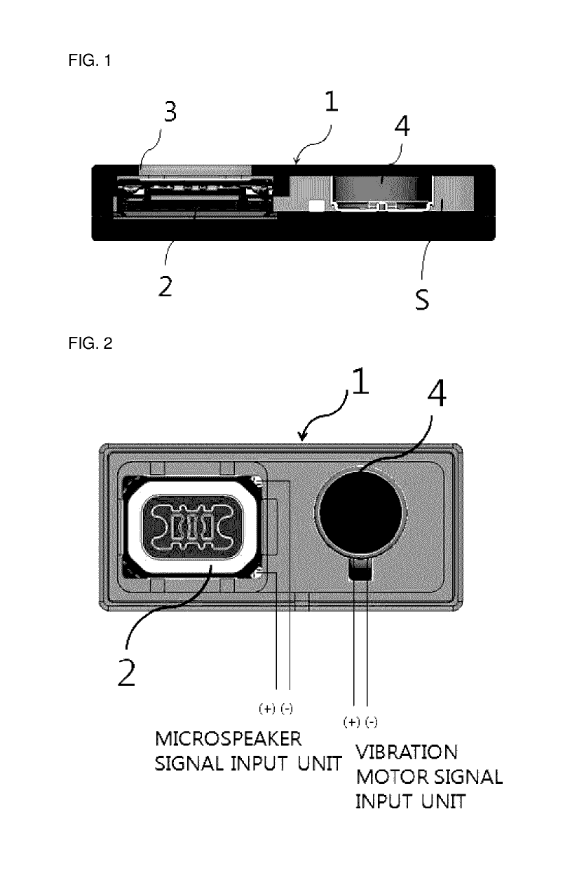

### DETAILED DESCRIPTION

Hereinafter, embodiments of the present invention will be described with reference to the accompanying drawings.

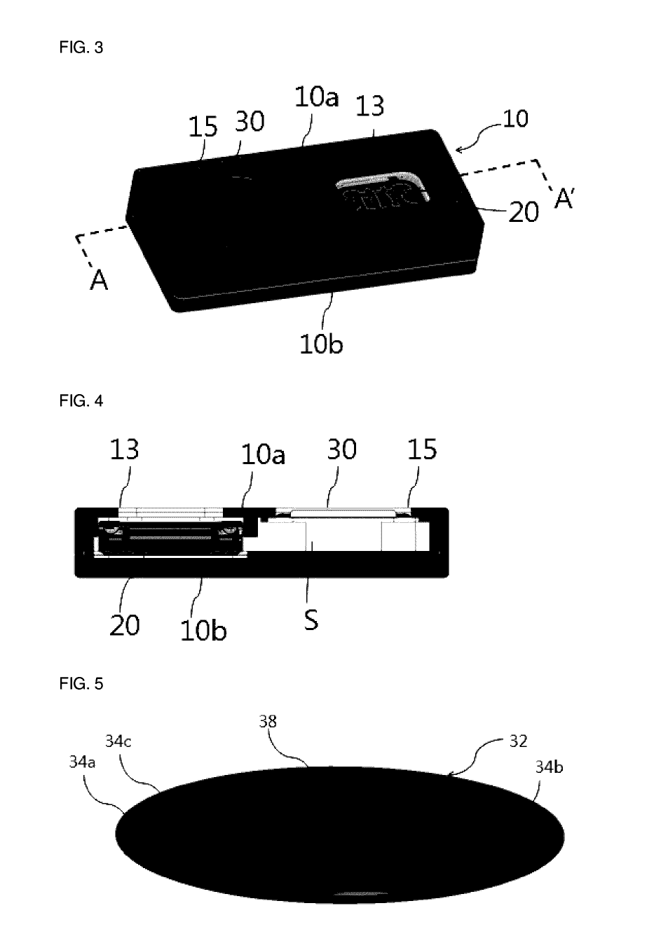

FIG. 3 is a perspective view of a microspeaker module having a subordinate vibration unit according to an embodiment of the present invention. FIG. 4 is a schematic cross-sectional view of the microspeaker module of FIG. 3, taken along line A-A′ of FIG. 3, and FIG. 5 is a detailed perspective view of the subordinate vibration unit of FIG. 3.

As illustrated in FIG. 3, the microspeaker module includes an enclosure 10 having a shape of a rectangular parallelepiped and serving as a sound box generating sound pressure therein, a microspeaker 20 installed on an upper surface of the enclosure 10 and changing an electrical signal into sound pressure to generate vibration of air, and a subordinate vibration unit 30 alleviating stiffness of air within the enclosure 10 and vibrating.

The enclosure 10, which is a part forming an overall outer appearance of the microspeaker module, includes an upper part 10a and a lower part 10b. A first opening 13 allowing a microspeaker 20 to be installed therein and a second opening 15 allowing the subordinate vibration unit 30 to be installed therein are provided on an upper surface of the upper part 10a. A grill (not shown) may be installed above the first and second openings 13 and 15.

The microspeaker 20 is a technique of a level that may be recognized by a person skilled in the art to which the present invention pertains, so a description thereof will be omitted. The microspeaker 20 is installed on a lower surface of the upper part 10a to correspond to a position of the first opening 13 within the enclosure 10 to emit a sound through the first opening 13.

The subordinate vibration unit 30, having predetermined mass and stiffness, is a component free from power or supply of an electric signal. The subordinate vibration unit 30 is installed in a lower surface of the upper part 10a to correspond to a position of the second opening 15 within the enclosure to emit a sound through the second opening 15. As illustrated in FIG. 4, a thickness of the subordinate vibration unit 30 is smaller than that of the microspeaker 10 to prevent a reduction in the volume of an internal space S.

As illustrated in FIG. 5, the subordinate vibration unit 30 includes a vibration plate 32 composed of an installation portion 34a attached to a lower surface of the upper part 10a, a central portion 34b on which a main body portion 38 is installed, and a dome portion 34c connecting the installation portion 34a and the central portion 34b. The main body portion 38 is formed of an iron, copper, or tungsten-based metal having high specific gravity to increase weight of the vibration plate 32.

The main body portion 38 is attached to the central portion 34b, and an opening may be formed at the center of the central portion 34b.

The subordinate vibration unit 30 is installed in the upper part 10a such that the dome portion 34c and the main body portion 38 are positioned within the second opening 15 without protruding from an upper surface of the upper part 10a even when the subordinate vibration unit 30 has maximum amplitude.

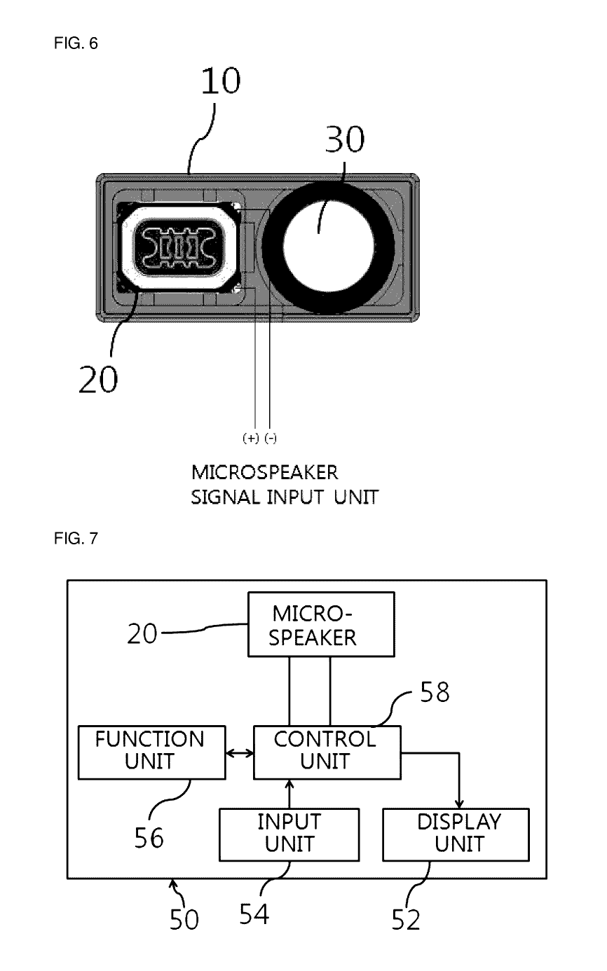

FIG. 6 is a plan view of the microspeaker of FIG. 3. As illustrated in FIG. 6, the microspeaker 20 includes a signal input unit receiving an electric signal from a control unit (illustrated in FIG. 7) of the electric device, and performs a vibration function and a sound emission (sound reproduction) function only with an electric signal applied through the signal input unit.

FIG. 7 is a block diagram of an electric device 50 including the microspeaker of FIG. 3. The electric device 50 includes a microspeaker 20, a display unit 52 displaying various types of information, an input unit 54 obtaining an input from a user, a function unit 56 performing an intrinsic function (for example, a communication function, a music reproduction function (or music playback function), a movie reproduction function, and a PC function) of the electric device 50, and a control unit 58 controlling the microspeaker 20, the display unit 52, the input unit 54, and the function unit 56. Here, a power supply unit (not shown), the display unit 52, the input unit 54, and the function unit 56 are techniques familiar to a person skilled in the art to which the present invention pertains, so a description thereof will be omitted.

In a case in which a vibration mode is set on the basis of current mode setting (vibration mode, sound reproduction mode), the control unit 58 generates a vibration electric signal including a vibration frequency region (for example, 150 Hz to 250 Hz) including a resonance frequency Df of the subordinate vibration unit 30 and applies the generated vibration electric signal to the microspeaker 20 for a vibration function of the microspeaker 20. Thus, the microspeaker 20 performs an operation. However, in the vibration frequency region, a reproduction sound pressure is very low and the vibration mode is conducted in a state in which vibration of the subordinate vibration unit 30 works considerably. The subordinate vibration unit 30 performs vibration immediately after an operation of the microspeaker 20, so a response speed is high.

The control unit 58 controls the microspeaker 20 using the foregoing vibration electric signal, when a vibration function is required, while performing an intrinsic function.

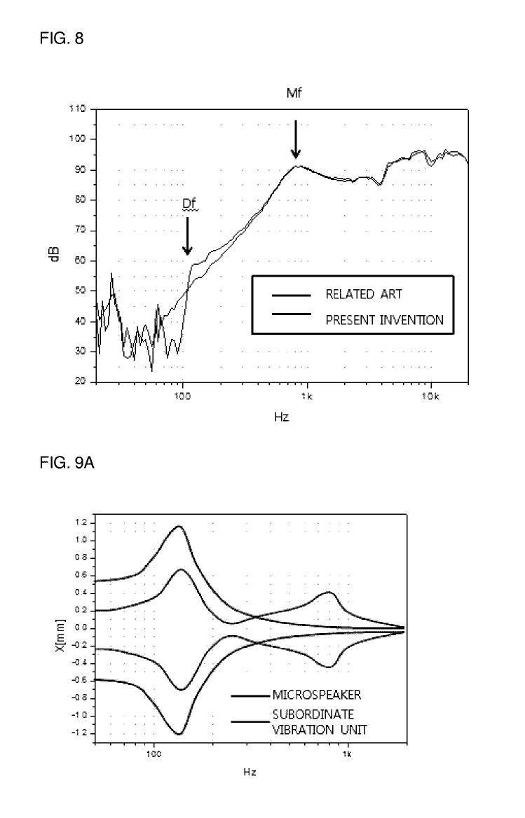

FIG. 8 is a graph illustrating sound pressure characteristics according to the present invention and the related art. As illustrated in FIG. 8, in the sound pressure characteristics graph of the microspeaker module according to the related art and the sound pressure characteristics graph of the microspeaker module having the subordinate vibration unit according to the present invention, it can be seen that the sound pressure characteristics are the same in the frequency region of about 400 Hz but the sound pressure characteristics (vibration) of the present invention is better in a low frequency band ranging from about 150 Hz to 400 Hz. In order to enhance the sound pressure characteristics (vibration) in the low frequency band, a resonance frequency Df of the subordinate vibration unit 30 needs to be lower than the resonance frequency Mf of the microspeaker 20. That is, the resonance frequency Df of the subordinate vibration unit 30 is set to range from about 150 Hz to 250 Hz to enhance vibration characteristics of the present invention.

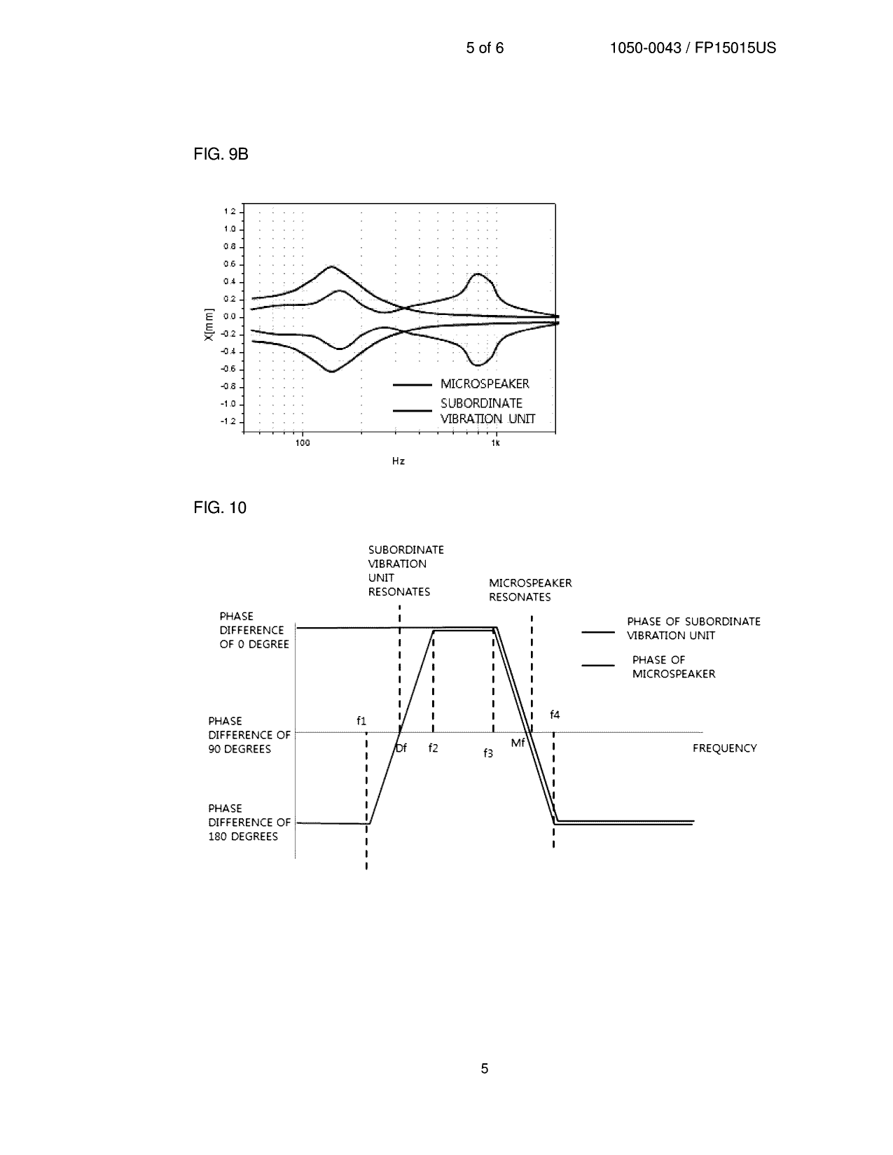

FIGS. 9A and 9B are sound pressure characteristics of the subordinate vibration unit and the microspeaker. FIG. 9A illustrates a case in which stiffness of the subordinate vibration unit 30 is lower than that of the microspeaker 20 (vibration plate) and FIG. 9B illustrates a case in which stiffness of the subordinate vibration unit 30 is higher than that of the microspeaker 20 (vibration plate).

In FIG. 9A, when stiffness of the subordinate vibration unit 30 is low, an amplitude of the microspeaker 30 is increased in the resonance frequency Df of the subordinate vibration unit 30, causing the vibration plate of the microspeaker 30 to be brought into contact with a yoke, a magnet, or a protector therein.

As illustrated in FIG. 9B, stiffness of the subordinate vibration unit 30 is increased and a weight is increased by the main body portion 38, whereby an excessive increase in the amplitude of the microspeaker 20 is prevented in the resonance frequency Df and sound pressure (vibration) in the low band frequency region is enhanced.

FIG. 10 is a phase characteristics graph of the subordinate vibration unit and the microspeaker. As illustrated, a difference between a phase of the microspeaker 20 and a phase of an electric signal input to the microspeaker 20 before the microspeaker 20 resonates is 0. The phase of the microspeaker 20 is increased from a frequency f3, and a phase difference is 90 degrees when the microspeaker 20 resonates. Thereafter, the phase difference is further increased to reach 180 degrees at a frequency f4 or after and maintained thusly.

In the case of the subordinate vibration unit 30, a phase difference of 180 degrees is made with respect to an input electric signal until a frequency f1 before the subordinate vibration unit 30 resonates. The phase difference is reduced from the frequency f1 to reach 90 degrees in the resonance frequency Df. The phase difference continues to be reduced and overlaps the phase characteristics graph of the microspeaker 20 at a frequency f2 and the same as the phase difference graph of the microspeaker 20 thereafter. As illustrated in FIG. 9B, although the vibration displacement (amplitude) of the subordinate vibration unit 30 is relatively reduced, an area of the subordinate vibration unit 30 (vibration plate 32) is increased to be greater than that of the vibration plate of the microspeaker 20 to increase a sound pressure compensation effect (vibration) in the low frequency band.

In particular, when the control unit 58 of the electric device 50 applies an electric signal having the resonance frequency Df of the subordinate vibration unit 30 to the microspeaker 20, the subordinate vibration unit 30 vibrates with a maximum amplitude in the resonance frequency Df, and since a phase difference between the subordinate vibration unit 30 and the microspeaker 20 is 90 degrees, a partial amount of sound is cancel out, and thus, vibration works more greatly than sound emission. In particular, since a reproduction sound pressure of the microspeaker 20 is remarkably low in a frequency ranging from 150 to 250 Hz, vibration of the subordinate vibration unit 30 works relatively greatly, whereby the microspeaker module performs the vibration function.

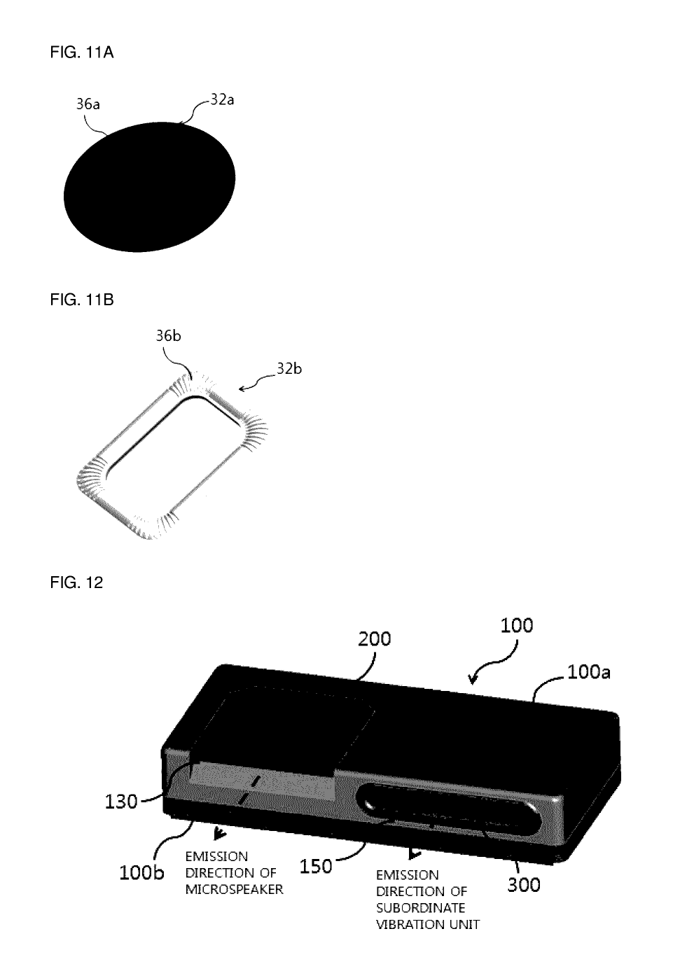

FIGS. 11A and 11B are views illustrating various examples of vibration plates of the subordinate vibration unit 30. As illustrated in FIG. 11A, the subordinate vibration unit 30 includes a circular vibration plate 32a and has a comb-pattern structure 36a in a dome portion thereof. The vibration plate 32a vibrates up and down linearly, minimizing partial vibration.

As illustrated in FIG. 11B, the subordinate vibration unit 30 includes a rectangular vibration plate 32b and has a comb-pattern structure 36b in a dome portion thereof. The vibration plate 32a vibrates up and down linearly, minimizing partial vibration.

FIG. 12 is a view illustrating a microspeaker module according to another embodiment of the present invention. Unlike the embodiment of FIG. 3, the microspeaker module includes an enclosure 100 including an upper layer part 100a and a lower layer part 100b coupled to the upper layer part 100a to form a space therein, a microspeaker 200 emitting a sound through a first opening 130 formed on an upper surface and a side surface of the upper layer part 100a, and a subordinate vibration unit 300 emitting a sound through a second opening 150 formed on a side surface of the upper layer part 100a. That is, sound emission directions of the microspeaker 200 and the subordinate vibration unit 300 are lateral directions.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An electric device, comprising:
a microspeaker module including a microspeaker;
a function unit configured to perform a function intrinsic to the electric device; and
a control unit configured to control the function unit to generate an electric signal and apply the generated electric signal to the microspeaker so as to simultaneously or selectively perform a vibration mode and a sound reproduction mode.

2. The electric device of claim 1, wherein the microspeaker module comprises:
an enclosure having an internal space and having a first opening provided on a first side surface to allow the microspeaker to be installed therein, and a second opening provided on a second side surface to allow a subordinate vibration unit to be installed therein;
a microspeaker configured to emit a sound through the first opening under the control of the control unit; and
a subordinate vibration unit configured to alleviate stiffness of air in the internal space of the enclosure.

3. The electric device of claim 2, wherein the control unit is configured to generate an electric signal including a vibration frequency region having a resonance frequency of the subordinate vibration unit, and to apply the generated electric signal to the microspeaker so as to perform a vibration mode.

4. The electric device of claim 3, wherein the vibration frequency region includes a frequency ranging from 150 to 250 Hz.

5. The electric device of claim 2, wherein the subordinate vibration unit comprises:
a vibration plate including an installation portion attached to a lower surface of the second side surface, a central portion on which a main body portion is installed, and a dome portion connecting the installation portion and the central portion,
wherein the main body portion increases the weight of the vibration plate.

6. The electric device of claim 5, wherein the main body portion is formed of a metal.

7. The electric device of claim 5, wherein the dome portion and the main body portion are positioned within a second opening when the subordinate vibration unit has a maximum amplitude.

8. The electric device of claim 5, wherein a resonance frequency of the subordinate vibration unit is lower than that of the microspeaker

9. The electric device of claim 5, wherein a stiffness of the subordinate vibration unit is higher than that of the microspeaker.

10. The electric device of claim 5, wherein the dome portion has a comb-pattern structure.
